(19) United States
(12) Patent Application Publication
(10) Pub. No.: US 2026/0342507 A1
(43) Pub. Date: Oct. 29, 2026

(54) REFERENCE SIGNAL CONFIGURATION METHOD AND APPARATUS, AND STORAGE MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 19/115,988

(22) PCT Filed: Sep. 28, 2022
(86) PCT No.: PCT/CN2022/122287

§ 371 Date: Mar. 27, 2025

(51) Int. Cl. H04L 5/00; H04W 72/232

(52) U.S. Cl. CPC H04L 5/0048; H04W 72/232

(57) ABSTRACT

A reference signal configuration method and apparatus, and a storage medium. The reference signal configuration method is applied to a network device. The method comprises: in response to determining that a terminal performs simultaneous transmission via multi-Panel (STxMP) on a physical uplink shared channel (PUSCH) on the basis of a single downlink control information (DCI) scheduling mode, sending phase-tracking reference signal (PT-RS) configuration information to the terminal, wherein the PT-RS configuration information is used for configuring the maximum number of PT-RS ports supported by the terminal when performing PT-RS transmission using a single panel or multiple panels in the STxMP transmission. The present disclosure can achieve the consistency between the maximum number of PT-RS ports supported by the terminal and the panel(s) during PT-RS transmission.

### CROSS-REFERENCE TO RELATED APPLICATION

The application is a U.S. National Stage of International Application No. PCT/CN2022/122287 filed on Sep. 28, 2022, the entire content of which is incorporated herein by reference.

### TECHNICAL FIELD

The present disclosure relates to the field of communication technology, and in particular, to a reference signal configuration method, apparatus and a storage medium.

### BACKGROUND

In the multi-transmission and reception point (multi-TRP) scenario, for the repeated transmission mode of the physical uplink shared channel (PUSCH)/physical uplink control channel (PUCCH), the uplink enhancement supports using time division multiplexing (TDM) multiplexing manner to send uplink channels to different transmission and reception points (TRPs) in different uplink beam directions. At present, the bottleneck of the communication system is still the uplink transmission rate and coverage. Therefore, the system enhancement direction of the R18 standard mainly considers the use of multi-antenna panel (multi-Panel) terminals for simultaneous uplink transmission in the Multi-TRP (also known as mTRP or M-TRP) scenario to increase the uplink rate and further improve the reliability of transmission.

### SUMMARY

The present disclosure provides a reference signal configuration method, apparatus and a storage medium.

According to a first aspect of the embodiments of the present disclosure, a reference signal configuration method is provided, which is applied to a network device, and the method includes:
in response to determining that a terminal performs a single downlink control information (DCI) scheduling mode based simultaneous transmission via multi-Panel (STxMP) physical uplink shared channel (PUSCH), sending a phase-tracking reference signal (PT-RS) configuration information to the terminal;
where the PT-RS configuration information is used to configure a maximum number of a PT-RS port supported by the terminal for sending a PT-RS using a single Panel or multi-Panel in an STxMP transmission.

According to a second aspect of the embodiments of the present disclosure, a reference signal configuration method is provided, which is applied to a terminal, and the method includes:
in response to the terminal performing a single downlink control information (DCI) scheduling mode based simultaneous transmission via multi-Panel (STxMP) physical uplink shared channel (PUSCH), receiving phase-tracking reference signal (PT-RS) configuration information sent by a network device;
where the PT-RS configuration information is used to configure a maximum number of a PT-RS port supported by the terminal for sending a PT-RS using a single panel or a multi-panel in an STxMP transmission.

According to a third aspect of the embodiments of the present disclosure, a reference signal configuration apparatus is provided, which is applied to a network device, and the apparatus includes:
a sending unit, configured to send phase-tracking reference signal (PT-RS) configuration information to a terminal in response to determining that the terminal performs a single downlink control information (DCI) scheduling mode based simultaneous transmission via multi-Panel (STxMP) physical uplink shared channel (PUSCH);
where the PT-RS configuration information is used to configure a maximum number of a PT-RS port supported by the terminal for sending a PT-RS using a single panel or a multi-panel in an STxMP transmission.

According to a fourth aspect of the embodiments of the present disclosure, a reference signal configuration apparatus is provided, which is applied to a terminal, and the apparatus includes:
a receiving unit, configured to receive phase-tracking reference signal (PT-RS) configuration information sent by a network device in response to the terminal performing a single downlink control information (DCI) scheduling mode based simultaneous transmission via multi-Panel (STxMP) physical uplink shared channel (PUSCH);
where the PT-RS configuration information is used to configure a maximum number of a PT-RS port supported by the terminal for sending a PT-RS using a single Panel or multi-Panel in the STxMP transmission.

According to a fifth aspect of the embodiments of the present disclosure, a reference signal configuration apparatus is provided, including:
a processor; and
a memory for storing instructions executable by the processor;
where the processor is configured to: execute the method described in the first aspect or any one of the implementations of the first aspect.

According to a sixth aspect of the embodiments of the present disclosure, a reference signal configuration apparatus is provided, including:
a processor; and
a memory for storing instructions executable by the processor;
where the processor is configured to: execute the method described in the second aspect or any one of the implementations of the second aspect.

According to the seventh aspect of the embodiments of the present disclosure, a storage medium is provided, in which instructions are stored. When the instructions in the storage medium are executed by a processor of a network device, the network device can execute the method described in the first aspect or any one of the implementations of the first aspect.

According to an eighth aspect of the embodiments of the present disclosure, a storage medium is provided, in which instructions are stored. When the instructions in the storage medium are executed by a processor of a network device, the network device is enabled to execute the method described in the second aspect or any one of the implementations of the second aspect.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the present disclosure.

FIG. 1 shows a schematic diagram of a wireless communication system for an uplink PT-RS port indication method.

FIG. 2 is a logic diagram of multi-panel transmission implementation based on S-DCI.

FIG. 3 shows a schematic diagram of a codeword-to-layer mapping scheme.

FIGS. 4A to 4D show schematic diagrams of a pattern design of front-load DMRS of two configuration types.

FIG. 5 is a flowchart showing a reference signal configuration method according to an exemplary embodiment.

FIG. 6 is a flowchart showing a reference signal configuration method according to an exemplary embodiment.

FIG. 7 is a flowchart of a method for determining a single Panel used by a terminal for sending a PUSCH from single Panel to single TRP according to an exemplary embodiment.

FIG. 8 is a flowchart of a method for determining a multi-panel used by a terminal for sending a PUSCH from multi-panel to multi-TRP according to an exemplary embodiment.

FIG. 9 is a flowchart showing a reference signal configuration method according to an exemplary embodiment.

FIG. 10 is a flowchart showing a reference signal configuration method according to an exemplary embodiment.

FIG. 11 is a flowchart of a method for determining a single Panel used by a terminal for sending a PUSCH from single Panel to single TRP according to an exemplary embodiment.

FIG. 12 is a flowchart of a method for determining a multi-panel used by a terminal for sending a PUSCH from multi-panel to multi-TRP according to an exemplary embodiment.

FIG. 13 is a block diagram of a reference signal configuration apparatus according to an exemplary embodiment.

FIG. 14 is a block diagram of a reference signal configuration apparatus according to an exemplary embodiment.

FIG. 15 is a block diagram showing an apparatus for configuring a reference signal according to an exemplary embodiment.

FIG. 16 is a block diagram showing an apparatus for configuring a reference signal according to an exemplary embodiment.

### DETAILED DESCRIPTION

Here, exemplary embodiments will be described in detail, examples of which are shown in the accompanying drawings. When the following description refers to the drawings, unless otherwise indicated, the same numbers in different drawings represent the same or similar elements. The implementations described in the following exemplary embodiments do not represent all implementations consistent with the present disclosure.

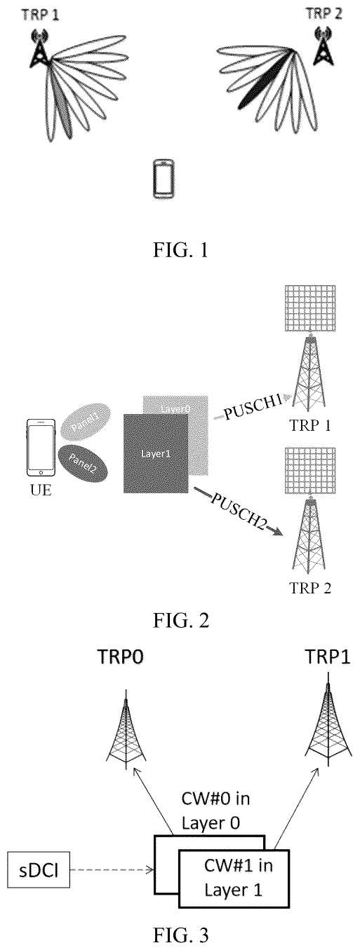

An uplink PT-RS port indication method provided by an embodiment of the present disclosure can be applied to a wireless communication system shown in FIG. 1. As shown in FIG. 1, the wireless communication system includes a network device and a terminal. The terminal is connected to the network device through a wireless resource and performs data transmission. The network device and the terminal perform data transmission based on a beam. The network device and the terminal can enhance PUSCH uplink transmission based on multi-TRP/Panel/TCI/TO.

It is understandable that the wireless communication system shown in FIG. 1 is only for schematic illustration, and the wireless communication system may also include other network device(s), such as a core network device, a wireless relay device, and a wireless backhaul device, which are not shown in FIG. 1. The embodiments of the present disclosure do not limit the number of the network devices and the number of the terminals included in the wireless communication system.

It can be further understood that the wireless communication system of the embodiments of the present disclosure is a network that provides the wireless communication function. The wireless communication system can adopt different communication technologies, such as a code division multiple access (CDMA), a wideband code division multiple access (WCDMA), a time division multiple access (TDMA), a frequency division multiple access (FDMA), an orthogonal frequency-division multiple access (OFDMA), a single carrier FDMA (SC-FDMA), a carrier sense multiple access/collision avoidance (Carrier Sense Multiple Access with Collision Avoidance). According to the capacity, rate, delay and other factors of different networks, the networks can be divided into the second generation (2G) network, 3G network, 4G network or future evolution network, such as 5G network, and 5G network can also be called New Radio (NR). For the convenience of description, the wireless communication network may sometimes be referred to as the network in the present disclosure.

Further, the network device involved in the present disclosure may also be referred to as a wireless access network device. The wireless access network device may be: a base station, an evolved node B (base station), a home base station, an access point (AP) in a wireless fidelity (WIFI) system, a wireless relay node, a wireless backhaul node, a transmission point (TP) or a transmission and reception point (TRP), etc. It may also be a gNB in the NR system, or it may also be a component or a part of device constituting the base station. It should be understood that in the embodiments of the present disclosure, the specific technology and specific device form adopted by the network device are not limited. In the present disclosure, the network device may provide communication coverage for a specific geographical area, and may communicate with a terminal located in the coverage area (cell). In addition, when it is a vehicle-to-everything (V2X) communication system, the network device may also be a vehicle-mounted device.

Furthermore, the terminal involved in the present disclosure may also be referred to as a terminal device, a user equipment (UE), a mobile station (MS), a mobile terminal (MT), etc., which is a device that provides voice and/or data connectivity to the user. For example, the terminal may be a handheld device, a vehicle-mounted device with a wireless connection function, etc. At present, some examples of the terminal are: a smart phone (Mobile Phone), a customer premise equipment (CPE), a Pocket Personal Computer (PPC), a palmtop computer, a personal digital assistant (PDA), a laptop computer, a tablet computer, a wearable device, or a vehicle-mounted device, etc. In addition, when it is a vehicle-to-everything (V2X) communication system, the terminal device may also be a vehicle-mounted device. It should be understood that the embodiments of the present disclosure do not limit the specific technology and specific device form adopted by the terminal.

In the multi-transmission and reception point (multi-TRP) scenario, for the repeated transmission mode of the physical uplink shared channel (PUSCH)/physical uplink control channel (PUCCH), the uplink enhancement supports using time division multiplexing (TDM) multiplexing to send uplink channels to different transmission and reception points (TRPs) in different uplink beam directions. At present, the bottleneck of the communication system is still the uplink transmission rate and coverage, etc. Therefore, the system enhancement direction of the R18 standard mainly considers the use of multi-antenna panel (multi-Panel) terminals for simultaneous uplink transmission in the Multi-TRP (also known as mTRP or M-TRP) scenario to increase the uplink rate and further improve the reliability of transmission.

In NR, in order to enhance signal coverage and improve signal quality, the network configures the phase-tracking reference signal (PT-RS) for the terminal as a UE-specific reference signal. PT-RS is used to track the phase noise introduced by the local oscillator in the network device and the terminal and is used to estimate the common phase error (CPE). PT-RS can be regarded as an extension of the demodulation reference signal (DMRS) and they have a close relationship, such as using the same precoding, port correlation, orthogonal sequence generation, quasi co-location (QCL) relationship, etc.

In uplink enhancement, in order to support the single downlink control information (single-DCI, S-DCI) based simultaneous transmission via multi-Panel (STxMP) scheme, it is necessary to consider different association mapping indication schemes between PT-RS and DMRS under different transmission multiplexing schemes, so as to support the method of enhancing PT-RS configuration when falling back to STRP transmission under STxMP transmission configuration in the case of multi-Panel terminal. STxMP refers to uplink simultaneous transmission via multi-Panel (STxMP) scheme.

In the related art, when a network device (such as a base station) has multiple TRPs, it can use M-TRP/multi-panel to provide services for the terminal, and Coordinated Multiple Point transmission (COMP) technology is introduced to enable the network device to provide a more balanced service quality within the service area. In one implementation, there is a corresponding relationship among Panel, TRP, Transmission Configuration Indication (TCI) and transmission occasion (TO), thus TRP/Panel/TCI/TO/TCI/TO, or multi-TRP/Panel/TCI/TO are used in the present disclosure. In all embodiments of the present disclosure, “/” means “or”.

Different from single-point transmission such as a single TRP or panel, coordinated multiple point transmission refers to multiple TRPs (Multi-TRP, mTRP or M-TRP)/Panel/TCI/TO providing data services for one user. The antenna array of each TRP can be divided into several relatively independent antenna panels, thus the shape and number of ports of the entire array can be flexibly adjusted according to the deployment scenario and service needs. The antenna panels or TRPs can also be connected by the optical fiber for more flexible distributed deployment. In the millimeter wave band, as the wavelength decreases, the blocking effect caused by obstacles such as human bodies or vehicles will be more significant. In this case, from the perspective of ensuring the robustness of the link connection, the coordination between/among multiple TRPs or panels can be used to perform transmission/reception through multiple beams at multiple angles, thereby reducing the adverse effect of the blocking effect.

The multiple stations involved in the COMP transmission procedure may correspond to multiple stations with different geographical locations or multiple sectors with different antenna panel orientations. For example, when a terminal receives data from different stations, the spatial differences between the stations will lead to differences in the large-scale channel parameters of the receiving links from different stations, such as Doppler frequency offset, delay spread, etc. The large-scale parameters of the channel may directly affect the adjustment and optimization of the filter coefficient during channel estimation. Different channel estimation filter parameters need to be used to adapt signals sent from different stations to the corresponding channel propagation characteristics.

Therefore, although the differences in spatial position or angle of each station are transparent to the UE and the COMP operation itself, the impact of the above spatial difference on the channel large-scale parameter is an important factor that the UE needs to consider when performing channel estimation and reception detection. Therefore, quasi-co-location (QUASI-CO-LOCATION, QCL) is introduced in the related art. QCL means that the large-scale parameter of the channel experienced by the symbol on a certain antenna port can be inferred from the channel experienced by the symbol on another antenna port. The large-scale parameter may include a delay spread, an average delay, a Doppler spread, a Doppler shift, an average gain, and a spatial reception parameter.

The so-called QCL of two antenna ports in the sense of certain large-scale parameters means that these large-scale parameters of the two ports are the same. In other words, as long as some large-scale parameters of the two ports are consistent, regardless of whether their actual physical locations or corresponding antenna panel orientations are different, the terminal can consider that the two ports are emitted from the same location (i.e., quasi-co-sited).

For some typical application scenarios, considering the possible QCL relationship between various reference signals, from the perspective of simplifying signaling, NR divides several channel large-scale parameters into the following four types to facilitate the system to perform configuration/indication according to different scenarios:
QCL-TypeA: {Doppler frequency shift, Doppler spread, average delay, delay spread}
Except the spatial reception parameter, all other large-scale parameters are the same.
For frequency bands below 6 GHz, the spatial reception parameter may not be required.
QCL-TypeB: {Doppler frequency shift, Doppler extension}
Only for 6 GHz
QCL-TypeC: {Doppler frequency shift, average delay}
QCL-TypeD: {spatial receiving parameter}

As mentioned before, since this parameter is mainly for the frequency bands above 6 GHz, it is treated as one separate QCL type.

In the Multi-TRP scenario, in the R17 standard, for the repeated transmission mode of PUSCH/PUCCH channel, the uplink enhancement supports that the uplink channel may be sent to different TRPs in different uplink beam directions by using time-division multiplexing (TDM) multiplexing mode.

At present, the bottleneck of the communication system is still the rate and coverage of uplink transmission, etc. Therefore, for the system enhancement direction of the R18 standard, the main consideration is to use the multi-panel terminal for simultaneous uplink transmission (STxMP) in the Multi-TRP scenario to increase the uplink rate and further improve the reliability of transmission, and to enhance the simultaneous transmission of PUSCH based on multi-panel of the terminal. The PUSCH enhancement based on Multi-TRP may be scheduled based on one piece of downlink control information (DCI) carried by one physical downlink control channel (PDCCH), such as a single downlink control signaling (single downlink control information, S-DCI) scheduling multi-TRP/Panel/TCI/TO transmission. It is also possible to consider scheduling based on different DCIs carried by different PDCCHs separately. FIG. 2 is a logic diagram of the implementation of multi-Panel sending based on single DCI (S-DCI). As shown in FIG. 2, the terminal (UE) transmits PUSCH1 and PUSCH2 to TRP1 and TRP2 through Panel1 and Panel2 based on transport layer (Layer) 1 and Layer 2, respectively.

In general, multiple physical panels are configured for the multi-panel implementation of the terminal, and the capabilities of different panels may also be different. For example, they have different maximum number of sounding reference signal (SRS) ports, and the maximum number of data transmission layers supported may not be the same. For example, one panel supports a maximum of 2 layers of transmission, and the other panel supports a maximum of 4 layers of transmission. The scheduler of the network device may judge whether the terminal is currently suitable for simultaneous uplink transmission of multiple panels. If the terminal is currently suitable for simultaneous uplink transmission and simultaneous scheduling of multiple panels, the network device may directly or indirectly indicate the relevant transmission parameters, including the terminal's specific beam indication information, the number of data layers used for transmission, and the allocation of DMRS ports used, as well as indication information of precoding, etc.

The method provided by the embodiments of the present disclosure is applicable to the DMRS port indication problem under S-DCI scheduling, that is, how to determine which DMRS ports are used for sending PUSCH on different panels respectively.

The current protocol supports a maximum of 4 uplink transmission layers, corresponding to the transmission of one codeword. Therefore, in multi-panel enhancement, there is another problem, which is how to support 2 codewords in the uplink to achieve flexible mapping. In the related art, in the uplink or downlink layer mapping scheme, the case where the number of data layers is 2-4 corresponds to the transmission of 1 codeword (codeWord, CW). However, this configuration makes it difficult for the same MCS to adapt to the channel conditions of different layers. Therefore, in the case that the inter-layer channel performance difference is large, performance loss will occur. Therefore, it is considered to apply 2 CWs for scheduling and transmission for data of 2-4 layers or only for data of 4 layers. FIG. 3 shows a schematic diagram of a codeword-to-layer layer mapping scheme. As shown in FIG. 3, in STxMP transmission under S-DCI scheduling, codeword 0 is mapped to layer 0 (CW #0 in Layer0) and codeword 1 is mapped to layer 1 (CW #1 in Layer1) for uplink transmission to TRP0 and TRP1. In this way, the network device can perform full scheduling according to the inter-layer channel condition. For example, for transmission of 3 layers, if the channel inter-layer difference is large, two CWs can be used for scheduling, one CW for transmission of data of 1 layer and the other CW for transmission of data of 2 layers. This also facilitates data retransmission scheduling and helps improve system throughput. The system focuses on transmission of less than 4 layers, thus it is also beneficial for overall performance optimization.

For the uplink synchronous transmission of multi-panel, the coordinated transmission scheduling of one TB of PUSCH based on a single DCI may support one or more transmission schemes including a Space Division Multiplexing (SDM) scheme, a Frequency Division Multiplexing (FDM) and a Single Frequency Network (SFN) scheme.

The space division multiplexing (SDM) scheme is mainly that one transport block (TB) of PUSCH sends different data layers on the same time-frequency resource respectively to two different TRPs through the corresponding DMRS port or port combination allocated on different Panels. Different TRPs/Panels/TCIs/TOs are associated with different beams/TCI states (i.e. beam indications).

The space division multiplexing (SDM) scheme includes two schemes: SDM-A and SDM-B.

SDM-A: different portions of one TB of PUSCH are sent to two different TRPs on the same time-frequency resource through their corresponding DMRS ports or port combinations allocated on different Panels, and different TRPs/Panels/TCIs/TOs are associated with different TCI states (TCIstate), i.e. beams.

SDM-B: the repetition of the same TB corresponding to different RV versions of PUSCH are sent to two different TRPs on the same time-frequency resource through the corresponding DMRS ports or port combinations allocated on different Panels, and different TRPs/Panels/TCIs/TOs are associated with different TCI states, i.e. beams.

For the frequency division multiplexing (FDM) scheme, one TB of PUSCH is sent on non-overlapping frequency domain resources on the same time domain resource to two different TRPs through the same DMRS port or port combination allocated on different Panels, and different TRPs/Panels/TCIs/TOs are associated with different TCI states, i.e. beams.

FDM has two possible schemes: FDM-A and FDM-B.

FDM-A: different portions of one TB of PUSCH are sent on non-overlapping frequency domain resources on the same time domain resource to two different TRPs through the same DMRS port or port combination allocated on different Panels, and different TRPs/Panels/TCIs/TOs are associated with different TCI states, i.e. beams.

FDM-B: the repetition of the same TB corresponding to different RV versions of PUSCH is sent on non-overlapping frequency domain resources on the same time domain resource to two different TRPs through the same DMRS port or port combination allocated on different Panels, and different TRPs/Panels/TCIs/TOs are associated with different TCI states, i.e., beams.

For the SFN solution, one TB of PUSCH is sent on the same time-frequency resource to two different TRPs through the same DMRS port or port combination allocated on different Panels, and different TRPs/Panels/TCIs/TOs are associated with different TCI states, i.e., beams.

Furthermore, the application of multi-TRP/Panel/TCI/TO is mainly to improve the coverage at the edge of the cell, provide a more balanced service quality in the service area, and perform coordinated data transmission in multi-TRP/Panel/TCI/TO using different manners. From the perspective of network morphology, network deployment with a large number of distributed access points plus baseband centralized processing will be more conducive to providing a balanced user experience rate and significantly reduce the delay and signaling overhead caused by handover. By utilizing the coordination in multiple TRPs or panels and transmitting/receiving channels through multiple beams at multiple angles, various occlusion/blocking effects can be better overcome, ensuring the robustness of link connections, which is suitable for URLLC services to improve transmission quality and meet reliability requirements.

In the R16 research phase, based on the application of coordinated multiple point transmission technology between downlink multiple TRPs (transmitting and receiving points)/antenna panels, transmission enhancement is performed on PDSCH. Since data transmission includes scheduling feedback of uplink and downlink channels, in the URLLC research, only enhancing the downlink data channel cannot guarantee the overall service performance. Therefore, in the R17 research, PDCCH, PUCCH and PUSCH will continue to be enhanced.

The PUSCH uplink transmission can be enhanced between the network device and the terminal based on multi-TRP/Panel/TCI/TO. Specifically, the uplink transmission scheme of PUSCH includes a codebook-based uplink transmission scheme and a non-codebook-based uplink transmission scheme.

In the related art, phase noise (PN) is caused by the execution of the local oscillator, which destroys the orthogonality of each subcarrier in the OFDM system, and this causes the common phase error (CPE), which causes the modulation constellation to rotate at a fixed angle and causes inter-carrier interference (ICI), whereby causing the scattering of the constellation points. This situation is more obvious at high frequencies. Since the impact of CPE is relatively great, the main consideration in NR is to compensate for CPE. In NR, the PT-RS signal is designed for estimation of CPE. In order to enhance signal coverage and improve signal quality, PT-RS is configured by the network to the terminal as a UE-specific reference signal. PT-RS is used to track the phase noise introduced by the local oscillator in the gNB and UE. PT-RS can be regarded as an extension of DMRS, and they have a close relationship, such as using the same precoding, port association, generation of orthogonal sequence, QCL relationship, etc.

The embodiments of the present disclosure are described below with reference to the association relationship between the PT-RS port and the DMRS port.

First, the DMRS port is described.

For PDSCH/PUSCH channels, the data layer of data transmission corresponds to the DMRS port used for demodulation. The DMRS design of the data channel (PDSCH/PUSCH) in the NR system mainly includes a Front-load DMRS and an Additional DMRS.

For the Front-load DMRS, the location where DMRS first appears needs be as close as possible to the starting point of scheduling in each scheduling time unit. The use of front-load DMRS helps the receiving side estimate the channel quickly and perform reception detection, which plays an important role in reducing latency and supporting the so-called self-contained structure. Depending on the total number of orthogonal DMRS ports, front-load DMRS can occupy up to two consecutive Orthogonal Frequency Division Multiplexing (OFDM) symbols.

The design ideas of Front-load DMRS are divided into two types. The first type (type 1) adopts a COMB+OCC structure, and the second type (type 2) adopts an FDM+OCC structure.

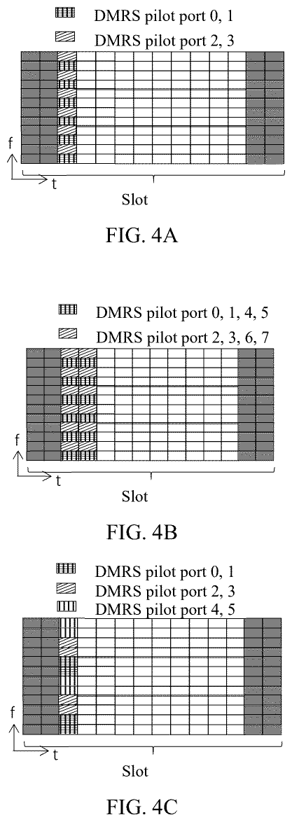

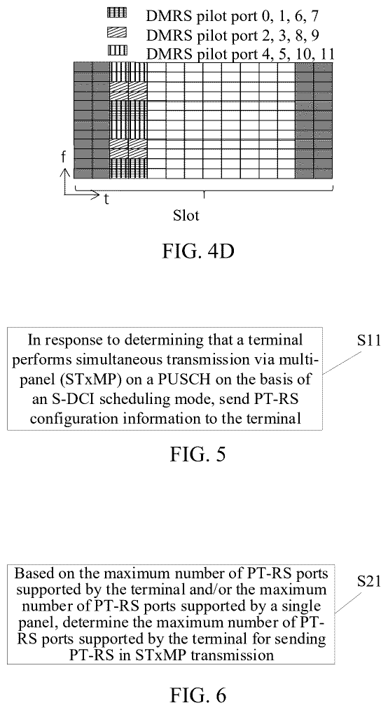

FIGS. 4A to 4D show schematic diagrams of pattern designs of the front-load DMRS of two configuration types. FIGS. 4A and 4B show schematic diagrams of DMRS pattern mapping for 1 OFDM symbol and 2 OFDM symbols corresponding to configuration type 1. FIGS. 4C and 4D show schematic diagrams of DMRS pattern mapping for 1 OFDM symbol and 2 OFDM symbols corresponding to configuration type 2.

The number of DMRS ports depends on the number of orthogonal ports used for transmission, and the front-load DMRS can be configured as two OFDM symbols at most. Considering the factor of power utilization efficiency, when using front-load DMRS of two symbols, TD-OCC is used in the time domain on the basis of CS or OCC in the frequency domain.

For low mobility scenarios, the front-load DMRS can achieve channel estimation performance that meets the demodulation requirement with a relatively low overhead. However, the mobile speed considered by the NR system can reach up to 500 km/h. Faced with such a large dynamic range of mobility, in medium/high speed scenarios, in addition to front-load DMRS, more DMRS symbols need to be inserted within the scheduling duration to meet the estimation accuracy of channel time variability. The NR system adopts a DMRS structure that combines the front-load DMRS with the additional DMRS with configurable time domain density. The pattern of each group of the additional DMRS is a repetition of the front-load DMRS. Therefore, consistent with the front-load DMRS, each group of additional DMRS can also occupy up to two consecutive DMRS symbols. Depending on the specific usage scenario, up to three groups of additional DMRS can be configured in each scheduling. The number of Additional DMRS depends on the high-level parameter configuration and the specific scheduling duration.

The relevant protocol provides the DMRS port allocation method with different parameter configurations under the uplink cyclic prefix orthogonal frequency-division multiplexing (CP-OFDM) waveform.

The following table shows the DMRS port allocation for different parameter configurations. In the following table, Value represents the code point, Number of DMRS CDM group(s) without data represents the number of DMRS CDM groups not occupied by data, DMRS port represents the DMRS port, and Number of front-load symbols represents the number of front-load symbols.

TABLE 1

| | Number of DMRS CDM | DMRS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Table 1 represents Antenna port(s), transform precoder is disabled, dmrs-Type=1 (DMRS type), maxLength (maximum length)=1, RANK (number of transmission layers)=1, that is, the DMRS port allocation diagram under the circumstance of DMRS type 1, single symbol, single stream transmission.

TABLE 2

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

Table 2 represents Antenna port(s), transform precoder is disabled, dmrs-Type=1 (DMRS type), maxLength (maximum length)=1, RANK (number of transmission layers)=2, that is, the DMRS port allocation diagram under the circumstance of DMRS type 1, single symbol, and dual-layer transmission.

TABLE 3

| | Number of DMRS CDM | DMRS |
|---|---|---|
| Value | group(s) without data | port(s) |
| 0 | 2 | 0-2 |
| 2-7 | Reserved | Reserved |

Table 3 represents Antenna port(s), transform precoder is disabled, dmrs-Type=1 (DMRS type), maxLength (maximum length)=1, RANK (number of transmission layers)=3, that is, the DMRS port allocation diagram under the circumstance of DMRS type 1, single symbol, and three-layer transmission.

TABLE 4

| | Number of DMRS CDM | DMRS |
|---|---|---|
| Value | group(s) without data | port(s) |
| 0 | 2 | 0-3 |
| 2-7 | Reserved | Reserved |

Table 4 represents Antenna port(s), transform precoder is disabled, dmrs-Type=1 (DMRS type), maxLength (maximum length)=1, RANK (number of transmission layers)=4, that is, the DMRS port allocation diagram under the circumstance of DMRS type 1, single symbol, four-layer transmission.

TABLE 5

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Table 5 represents Antenna port(s), transform precoder is disabled, dmrs-Type=1 (DMRS type), maxLength (maximum length)=2, RANK (number of transmission layers)=1, that is, the DMRS port allocation diagram under the circumstance of DMRS type 1, two symbols, and single stream transmission.

TABLE 6

| | Number of DMRS CDM | DMRS | Number of front- |
|---|---|---|---|
| Value | group(s) without data | port(s) | load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Table 6 represents Antenna port(s), transform precoder is disabled, dmrs-Type=1 (DMRS type), maxLength (maximum length)=2, RANK (number of transmission layers)=2, that is, the DMRS port allocation diagram under the circumstance of DMRS type 1, two symbols, and two-layer transmission.

TABLE 7

| | Number of DMRS CDM | DMRS | Number of front- |
|---|---|---|---|
| Value | group(s) without data | port(s) | load symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

Table 7 represents Antenna port(s), transform precoder is disabled, dmrs-Type=1 (DMRS type), maxLength (maximum length)=2, RANK (number of transmission layers)=3, that is, the DMRS port allocation diagram under DMRS type 1, two symbols, and three-layer transmission.

TABLE 8

| | Number of DMRS CDM | DMRS | Number of front- |
|---|---|---|---|
| Value | group(s) without data | port(s) | load symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

Table 8 represents Antenna port(s), transform precoder is disabled, dmrs-Type=1 (DMRS type), maxLength (maximum length)=2, RANK (number of transmission layers)=2, that is, the DMRS port allocation diagram under DMRS type 1, two symbols, and four-layer transmission.

TABLE 9

| | Number of DMRS CDM | DMRS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

Table 9 represents Antenna port(s), transform precoder is disabled, dmrs-Type=2 (DMRS type), maxLength (maximum length)=1, RANK (number of transmission layers)=1, that is, the DMRS port allocation diagram under DMRS type 2, single symbol, single layer transmission.

TABLE 10

| | Number of DMRS CDM | DMRS |
|---|---|---|
| Value | group(s) without data | port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

Table 10 represents Antenna port(s), transform precoder is disabled, dmrs-Type=2 (DMRS type), maxLength (maximum length)=1, RANK (number of transmission layers)=2, that is, the DMRS port allocation diagram under DMRS type 2, single symbol, and two-layer transmission.

TABLE 11

| | Number of DMRS CDM | DMRS |
|---|---|---|
| Value | group(s) without data | port(s) |
| 0 | 2 | 0-2 |
| 1 | 3 | 0-2 |
| 2 | 3 | 3-5 |
| 3-15 | Reserved | Reserved |

Table 11 represents Antenna port(s), transform precoder is disabled, dmrs-Type=2 (DMRS type), maxLength (maximum length)=1, RANK (number of transmission layers)=3, that is, the DMRS port allocation diagram under DMRS type 2, single symbol, and three-layer transmission.

TABLE 12

| | Number of DMRS CDM | DMRS |
|---|---|---|
| Value | group(s) without data | port(s) |
| 0 | 2 | 0-3 |
| 1 | 3 | 0-3 |
| 2-15 | Reserved | Reserved |

Table 12 represents Antenna port(s), transform precoder is disabled, dmrs-Type=2 (DMRS type), maxLength (maximum length)=1, RANK (number of transmission layers)=4, that is, the DMRS port allocation diagram under DMRS type 2, single symbol, four-layer transmission.

TABLE 13

| | Number of DMRS CDM | DMRS | Number of front- |
|---|---|---|---|
| Value | group(s) without data | port(s) | load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

Table 13 represents Antenna port(s), transform precoder is disabled, dmrs-Type=2 (DMRS type), maxLength (maximum length)=2, RANK (number of transmission layers)=1, that is, the DMRS port allocation diagram in the case of DMRS type 2, two symbols, and single transmission.

TABLE 14

| | Number of DMRS CDM | DMRS | Number of front- |
|---|---|---|---|
| Value | group(s) without data | port(s) | load symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

Table 14 represents Antenna port(s), transform precoder is disabled, dmrs-Type=2 (DMRS type), maxLength (maximum length)=2, RANK (number of transmission layers)=2, that is, the DMRS port allocation diagram in the case of DMRS type 2, two symbols, and dual-layer transmission.

TABLE 15

| | Number of DMRS CDM | DMRS | Number of front- |
|---|---|---|---|
| Value | group(s) without data | port(s) | load symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

Table 15 represents Antenna port(s), transform precoder is disabled, dmrs-Type=2 (DMRS type), maxLength (maximum length)=2, RANK (number of transmission layers)=3, that is, the DMRS port allocation diagram under DMRS type 2, two symbols, and three-layer transmission.

TABLE 16

| | Number of DMRS CDM | DMRS | Number of front- |
|---|---|---|---|
| Value | group(s) without data | port(s) | load symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

Table 16 represents Antenna port(s), transform precoder is disabled, dmrs-Type=2 (DMRS type), maxLength (maximum length)=2, RANK (number of transmission layers)=4, that is, the DMRS port allocation diagram under DMRS type 2, two symbols, and four-layer transmission.

The PT-RS port is described below.

The number of PT-RS ports is related to the number of phase noise sources. When there are multiple independent phase noise sources, each phase noise source requires one PT-RS port for phase estimation. In the related art, 1 PT-RS port for downlink and 2 PT-RS ports for uplink are supported.

In the related art, whether to transmit PT-RS in uplink is configured through a high-level parameter (DMRS-UplinkConfig, PT-RS-UplinkConfig).

For example, phase TrackingRS is configured for the UE in the high-level parameter DMRS-UplinkConfig to configure the uplink transmission of PT-RS. If the high-level parameter DMRS-UplinkConfig does not include phase TrackingRS configured for the UE, the PT-RS is not transmitted in the uplink transmission of the terminal.

There is an association relationship between the PT-RS port and the DMRS port, which is indicated by a PT-RS-DMRS association indication field.

In an example, if the high-level parameter configures the UE with the parameter UL-PT-RS-present, and the number of PT-RS ports is 1 or 2, then the PT-RS-DMRS association indication field in UL DC10_1/0_2 indicates that one DMRS port is associated with this PT-RS port. The specific association relationship is shown in the following table.

For the case of a single PT-RS port, Table 17 shows the association relationship between the PT-RS port and the DMRS port for uplink PT-RS port 0.

TABLE 17

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

For the case of two PT-RS ports, Table 18 shows the association relationship between the PT-RS port and the DMRS port for uplink PT-RS port 0.

TABLE 18

| Value of MSB | DMRS port | Value of LSB | DMRS port |
|---|---|---|---|
| 0 | 1^{st} DMRS port | 0 | 1^{st} DMRS port |
| | which shares PT- | | which shares PT- |
| | RS port 0 | | RS port 1 |
| 1 | 2^{nd} DMRS port | 1 | 2^{nd} DMRS port |
| | which shares PT- | | which shares PT- |
| | RS port 0 | | RS port 1 |

The maximum number of PT-RS ports is obtained by configuring maxNrofPorts in the high-level parameter PT-RS-UplinkConfig to ‘n2’. If the maximum number of PT-RS ports indicated by n2 is 2, the network device actually divides the DMRS ports corresponding to the SRS resources into two groups, and confirms the association relationship indications of individual PT-RS ports respectively.

In the related art, according to the mapping relationship between the sending signal flow and multi-TRP/Panel/TCI/TO, the transmission mode of the coordinated multiple point transmission technology includes codebook-based transmission and non-codebook-based transmission. The codebook-based transmission can include full coherent, partial coherent and non coherent.

For the codebook-based transmission, if it is a transmission that is fully coherent, the bit overhead of the association relationship indication between the DMRS and PT-RS depends on the number of transmission antennas and TRI. If it is a partial coherent/non coherent transmission, and if the indicated maximum number of PT-RS ports is 1, one port is required for transmission and corresponds to one sounding reference signal (SRS) resource. If the indicated maximum number of PT-RS ports is 2, the number of UL PT-RS ports actually transmitted and the number of layers associated with them are determined by the precoding matrix (Transmission Precoding matrix indicator, TPMI) and the number of transmission layers (TRI) indication. If the number of layers indicated by TPMI from one SRS port group is 1 or 2, one PT-RS port needs to be scheduled, otherwise two PT-RS ports need to be scheduled. For uplink transmission with 3 layers, two PT-RS ports need to be scheduled.

For the non-codebook based uplink transmission, if the configured SRS resources contain the same PT-RS port index, then these resources share one PT-RS port, and the corresponding UL DMRSs are also associated with the same PT-RS port. That is, the number of scheduled UL PT-RS ports is determined according to the SRI.

In the uplink enhancement of R18, consideration is given to how to support higher throughput and more reliable transmission performance through simultaneous uplink transmission of multi-TRP/Panel/TCI/TO.

In order to support the uplink simultaneous transmission via multi-panel scheme based on single-DCI, it is necessary to consider different association mapping indication schemes between PT-RS and DMRS under different transmission multiplexing schemes when falling back to single TRP transmission under STxMP transmission configuration, so as to support accurate estimation of CPE of the terminal in the case of multi-panel. Although in the related art, the maximum number of PT-RS ports supported by the terminal is configured in the Radio Resource Control (RRC) configuration, this method still has some defects. For example, when falling back to STRP transmission under STxMP transmission configuration, PT-RS under a single panel cannot be accurately sent. If only the entire maximum number of PT-RS ports sent by the terminal is configured, for example, 2, it is unclear whether the maximum number of PT-RS ports corresponding to the sending panel used by STRP transmission is 1 or 2, resulting in the problem of being unable to uniquely indicate the association relationship between the PT-RS actually sent by the terminal and the DMRS. In addition, there are not enough specific PT-RS configuration enhancement methods to send PT-RS accurately under a single panel.

In view of this, an embodiment of the present disclosure provides a reference signal configuration method for configuring the maximum number of PT-RS ports for the Panel, so that the maximum number of PT-RS ports supported for sending PT-RS using a single panel or multi-panel can be determined in STxMP transmission.

FIG. 5 is a flowchart of a reference signal configuration method according to an exemplary embodiment. As shown in FIG. 5, the reference signal configuration method is applied to a network device and includes the following steps.

In step S11, in response to determining that the terminal performs the S-DCI scheduling mode based simultaneous transmission via multi-panel (STxMP) PUSCH, PT-RS configuration information is sent to the terminal.

In the embodiments of the present disclosure, the PT-RS configuration information is used to configure the maximum number of PT-RS ports supported by the terminal for sending PT-RS using a single panel or multi-panel in STxMP transmission.

In the embodiments of the present disclosure, in response to the terminal performing the S-DCI scheduling mode based simultaneous transmission via multi-panel (STxMP) PUSCH, the network device sends PT-RS configuration information to the terminal. The PT-RS configuration information is used to configure the maximum number of PT-RS ports supported by the terminal for sending PT-RS using a single panel or multi-panel in STxMP transmission. Therefore, the configuration of the maximum number of PT-RS ports at the Panel level is implemented, so that the maximum number of PT-RS ports supported for sending PT-RS using a single panel or multi-panel can be determined in STxMP transmission.

In one implementation provided by the embodiments of the present disclosure, the configuration enhancement for the maximum number of PT-RS ports may be to increase the configuration of the maximum number of PT-RS ports corresponding to per Panel. In one example, the port configuration of per Panel is added to the current RRC configuration. For example, taking the existence of two Panels as an example, the maximum number of PT-RS ports corresponding to per Panel is configured in the configuration information. Specifically, the port configuration information corresponding to per Panel is added to the current RRC configuration information, and the configuration information is panelMaxNrofPorts1 and panelMaxNrofPorts2, respectively.

The panelMaxNrofPorts1 corresponds to the first TRP/Panel/TCI/TO, and panelMaxNrofPorts2 corresponds to the second TRP/Panel/TCI/TO. The parameter configuration of Panel1 and Panel2 is added in the IE parameter list. As shown below, the parameter configuration is:

{......
panelMaxNrofPorts1 ENUMERATED{n1,n2},
panelMaxNrofPorts2 ENUMERATED{n1,n2},
......}

The ENUMERATED function is used to group the number of PT-RS ports supported by per Panel into one index sequence, and ENUMERATED is used to simultaneously obtain the index and value of per Panel to obtain the maximum number of PT-RS ports supported by per Panel.

In one implementation of the embodiments of the present disclosure, the PT-RS configuration information is used to configure the maximum number of PT-RS ports supported by per panel for sending PT-RS.

In another implementation of the embodiments of the present disclosure, the PT-RS configuration information is used to configure the maximum number of PT-RS ports supported by the terminal for sending PT-RS in STxMP transmission, which can be understood as configuring the maximum number of PT-RS ports at the terminal level.

In another implementation of the embodiments of the present disclosure, the PT-RS configuration information is used to configure the maximum number of PT-RS ports supported by per Panel for sending PT-RS and the maximum number of PT-RS ports supported by the terminal for sending PT-RS in STxMP transmission. It can be understood that the PT-RS configuration information is used to configure the maximum number of PT-RS ports at the panel level and the maximum number of PT-RS ports at the terminal level.

In the embodiments of the present disclosure, the maximum number of PT-RS ports supported by the terminal for sending PT-RS in STxMP transmission is determined based on the maximum number of PT-RS ports supported by the terminal and/or the maximum number of PT-RS ports supported by a single Panel.

FIG. 6 is a flowchart of a reference signal configuration method according to an exemplary embodiment. As shown in FIG. 6, the method includes the following steps.

In step S21, based on the maximum number of PT-RS ports supported by the terminal and/or the maximum number of PT-RS ports supported by a single Panel, the maximum number of PT-RS ports supported by the terminal for sending PT-RS in STxMP transmission is determined.

In the embodiments of the present disclosure, the maximum numbers of PT-RS ports supported by the single Panel and the terminal are determined through RRC configuration information.

For example, in order to determine the maximum number of PT-RS ports supported by a single Panel, based on panelMaxNrofPorts added in the RRC configuration information, the configuration of the maximum number of PT-RS ports supported by per Panel is obtained to determine the maximum number of PT-RS ports supported by the single Panel.

For example, for determining the maximum number of PT-RS ports supported by the terminal: the maximum number of PT-RS ports supported by the terminal is determined through the current RRC configuration information.

In the embodiments of the present disclosure, the maximum number of PT-RS ports supported by the terminal and/or the maximum number of PT-RS ports supported by the single Panel is determined according to the above-mentioned method, and based on the maximum number of PT-RS ports supported by the terminal and/or the maximum number of PT-RS ports supported by the single Panel, the maximum number of PT-RS ports supported by the terminal for sending PT-RS in STxMP transmission is determined, so that the maximum number of PT-RS ports supported by the terminal for sending PT-RS in STxMP transmission is consistent with the maximum number of PT-RS ports supported by the Panel for sending PT-RS in STxMP transmission, thereby achieving consistent understanding of the configuration between the Panel and the terminal when sending PT-RS in STxMP transmission.

In one implementation of the embodiments of the present disclosure, if the current transmission falls back to the STRP transmission state, that is, the terminal sends PUSCH from single Panel to single TRP, the maximum number of PT-RS ports corresponding to the sending Panel indicated under STRP should according to the maximum number of PT-RS ports configured by the network device for this Panel.

Under S-DCI, the Panel used by the terminal when falling back to the STRP transmission state can be determined by the SRS resource set indicator indication field in the DCI. The SRS resource set indicator indication field is used to indicate the dynamic switching of single TRP/Panel/TCI/TO and multi-TRP/Panel/TCI/TO, and different code points can be used to indicate which TRP/Panel/TCI/TO is used when sending under a single TRP/Panel/TCI/TO.

In one implementation of the reference signal configuration method provided by an embodiment of the present disclosure, in response to the terminal being in STxMP transmission, based on an SRS resource set indicator indication field, a single Panel used by the terminal for sending PUSCH from a single Panel to a single TRP is determined, and the maximum number of PT-RS ports configured by the network device for the determined single Panel is determined as the maximum number of PT-RS ports supported by the single Panel for sending PT-RS in sending PUSCH from a single Panel to a single TRP.

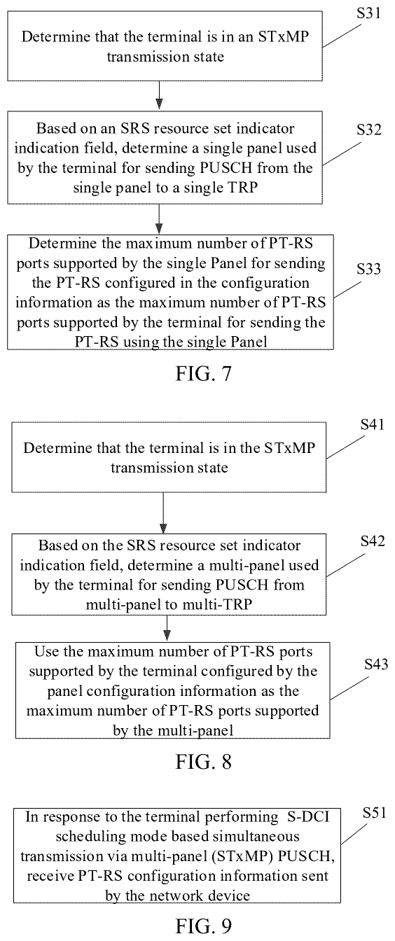

FIG. 7 is a flowchart of a method for determining a single Panel used by the terminal for sending PUSCH from a single Panel to a single TRP according to an exemplary embodiment. As shown in FIG. 7, the method includes the following steps.

In step S31, it is determined that the terminal is in an STxMP transmission state.

In step S32, based on an SRS resource set indicator indication field, the single Panel used by the terminal for sending PUSCH from a single panel to a single TRP is determined.

In step S33, a maximum number of PT-RS ports supported by the single Panel for sending PT-RS configured in the configuration information is determined as the maximum number of PT-RS ports supported by the terminal for sending PT-RS using the single Panel.

In the embodiments of the present disclosure, the maximum number of PT-RS ports supported by the terminal for sending PT-RS in PUSCH transmission from a single Panel to a single TRP is the maximum number of PT-RS ports supported by the terminal configured by the configuration information, which can accurately determine the maximum number of PT-RS ports supported for sending PT-RS using a single Panel, and then can accurately determine the maximum number of PT-RS ports supported by sending PT-RS on the single Panel when falling back to STRP transmission under the STxMP transmission configuration.

In one implementation of the reference signal configuration method provided by an embodiment of the present disclosure, in response to the terminal being in STxMP transmission, based on an SRS resource set indicator indication field, a multi-Panel used by the terminal for sending PUSCH from multi-panel to multi-TRP is determined, and the maximum number of PT-RS ports supported by the multi-panel is the maximum number of PT-RS ports supported by the terminal configured by the configuration information.

FIG. 8 is a flowchart of a method for determining a multi-panel used by a terminal to send PUSCH from multi-panel to multi-TRP according to an exemplary embodiment. As shown in FIG. 8, the method includes the following steps.

In step S41, it is determined that the terminal is in the STxMP transmission state.

In step S42, based on the SRS resource set indicator indication field, a multi-panel used by the terminal for sending PUSCH from multi-panel to multi-TRP is determined.

In step S43, the maximum number of PT-RS ports supported by the terminal configured by the Panel configuration information is used as the maximum number of PT-RS ports supported by the multi-panel.

In the embodiments of the present disclosure, the maximum number of PT-RS ports supported by the multi-panel for sending PT-RS used by the terminal for sending PUSCH from multi-panel to multi-TRP is the maximum number of PT-RS ports supported by the terminal configured by the configuration information, which can accurately determine the maximum number of PT-RS ports supported for sending PT-RS using the multi-panel.

In the embodiments of the present disclosure, in the PUSCH transmission of the terminal from single Panel to single TRP, the number of PT-RS ports actually transmitted by the single Panel is determined based on the number of PUSCH transmission streams in the PUSCH transmission, the grouping of antenna ports corresponding to the number of transmission streams, and the maximum number of PT-RS ports supported by the Panel.

The above method is used to determine the number of PUSCH transmission streams and the grouping of antenna ports corresponding to the number of transmission streams in PUSCH transmission. According to the maximum number of PT-RS ports supported by the Panel, the number of PT-RS ports actually transmitted by a single Panel in the PUSCH transmission from single Panel to single TRP of the terminal is determined.

Based on the method for configuring the maximum number of PT-RS ports involved in the above embodiments of the present disclosure, it is possible to achieve consistent understanding of configuration between the Panel and the terminal when sending PT-RS in STxMP transmission. The effect of consistent understanding of configuration between the Panel and the terminal is described below in combination with actual applications.

In the implementation scheme of configuring the maximum number of PT-RS ports supported by the terminal in the conventional technology, that is, only configuring the maximum number of PT-RS ports per UE, for example, configuring it to 2, then when falling back to sending of a certain panel, the following situations may occur.

1) It can only be processed according to the default configuration that the maximum number of ports for sending PT-RS on the panel is 2. However, if the actual capability of the panel is the maximum PT-RS single port, for example, if all antenna ports on the panel are full coherent, the terminal reports according to the PT-RS single port capability, but the network device will understand that the terminal is reporting according to the PT-RS of 2 ports. In this way, the understanding of the terminal and the base station will be inconsistent. In the future, the protocol may also be extended to consider the case of PT-RS of 4 ports. In this case, under the PT-RS configuration of PT-RS with a maximum of 4 ports per UE, the capability difference of different panels will be great.

2) Even if the antenna ports on the panel are grouped, if the actual network configuration needs to limit the PT-RS overhead or is based on some considerations of simplified implementation, a maximum of one PT-RS port may be directly configured, and in this case, the indication may be made according to the association relationship of the single-port PT-RS. For example, in STXMP transmission, even if a maximum of two PT-RS ports are configured per UE, the network may want to configure per panel that can actually support two ports to support only one PT-RS port at most, which can not be supported by the existing signaling.

However, by applying the method provided by the embodiments of the present disclosure, the network device not only configures the maximum PT-RS port of per UE, but also configures the maximum number of PT-RS ports per Panel.

In an exemplary embodiment, descriptions are given by using an example in which the current STxMP transmission falls back to a single TRP transmission state, the maximum number of ports supported by TRP for sending PT-RS is 2, and it falls back to a single Panel for sending PT-RS. If the number of ports that the single Panel can support for sending PT-RS is 2, the maximum number of PT-RS ports supported by TRP is configured according to the maximum number of PT-RS ports that can be supported on the single Panel as the configuration information, and TRP reports according to the maximum number of PT-RS ports supported for sending PT-RS to be 2. If the actual number of ports for sending PT-RS by the single Panel is 1 (for example, when all antenna ports are full coherent), TRP configures according to the maximum number of PT-RS ports supported for sending PT-RS to be 1 as the configuration information.

In another exemplary embodiment, descriptions are given by using an example in which the current STxMP transmission falls back to the single TRP transmission state, the maximum number of ports supported by the TRP for sending PT-RS is 2, and it falls back to a single Panel for sending PT-RS. For example, if the actual network configuration needs to limit the PT-RS overhead or is based on some considerations of simplified implementation, the maximum number of PT-RS ports supported for sending is input as 1 in the configuration information for configuration. According to the configuration information, the single Panel configures the maximum number of PT-RS ports supported for sending PT-RS to be 1, and the TRP configures the maximum number of PT-RS ports supported for sending PT-RS to be 1, thereby achieving consistency in the maximum number of PT-RS ports supported for sending PT-RS on the TRP and the single Panel.

In future technological development, it may be extended to the transmission in STxMP. Even if a maximum of 4 PT-RS ports are configured for per UE, the network may want to configure each Panel that can actually support 2 ports to support only 1 PT-RS port at most. Therefore, the method of configuring the maximum number of PT-RS ports per Panel provided in the embodiments of the present disclosure will enable the sending panel used for STRP transmission to accurately determine the supported maximum number of PT-RS ports.

It can be understood that the transmission mode of PUSCH transmission involved in the above embodiments of the present disclosure includes a PUSCH transmission mode based on scheduling, or a configured grant Type 1, or a configured grant Type 2. That is, the reference signal configuration method provided in the embodiments of the present disclosure is applicable to the PUSCH transmission mode based on scheduling, the configured grant Type 1, and the configured grant Type 2.

Based on the same concept, the embodiment of the present disclosure also provides a reference signal configuration method applied to a terminal. FIG. 9 is a flowchart of a reference signal configuration method according to an exemplary embodiment. As shown in FIG. 9, the reference signal configuration method is applied to a terminal and includes the following steps.

In step S51, in response to the terminal performing the S-DCI scheduling mode based simultaneous transmission via multi-panel (STxMP) PUSCH, PT-RS configuration information sent by the network device is received.

In the embodiments of the present disclosure, the PT-RS configuration information is used to configure the maximum number of PT-RS ports supported by the terminal for sending PT-RS using a single panel or multi-panel in STxMP transmission. In the embodiments of the present disclosure, in response to the terminal performing the S-DCI scheduling mode based simultaneous transmission via multi-panel (STxMP) PUSCH, the network device sends PT-RS configuration information to the terminal. The PT-RS configuration information is used to configure the maximum number of PT-RS ports supported by the terminal for sending PT-RS using a single panel or multi-panel in STxMP transmission. Therefore, the configuration of the maximum number of PT-RS ports at the panel level is implemented, so that the maximum number of PT-RS ports supported for sending PT-RS using a single panel or multi-panel can be determined in STxMP transmission.

In one implementation, the T-RS configuration information is used to configure the maximum number of PT-RS ports supported by per single Panel for sending PT-RS.

In one implementation, the PT-RS configuration information is used to configure the maximum number of PT-RS ports supported by per single Panel for sending PT-RS.

In one implementation, the PT-RS configuration information is also used to configure the maximum number of PT-RS ports supported by the terminal for sending PT-RS in STxMP transmission, which can be understood as configuring the maximum number of PT-RS ports at the terminal level.

In another implementation of the embodiments of the present disclosure, the PT-RS configuration information is used to configure the maximum number of PT-RS ports supported by per Panel for sending PT-RS and the maximum number of PT-RS ports supported by the terminal for sending PT-RS in STxMP transmission. It can be understood that the PT-RS configuration information is used to configure the maximum number of PT-RS ports at the panel level and the maximum number of PT-RS ports at the terminal level.

In the embodiments of the present disclosure, the maximum number of PT-RS ports supported by the terminal for sending PT-RS in STxMP transmission is determined based on the maximum number of PT-RS ports supported by the terminal and/or the maximum number of PT-RS ports supported by a single panel.

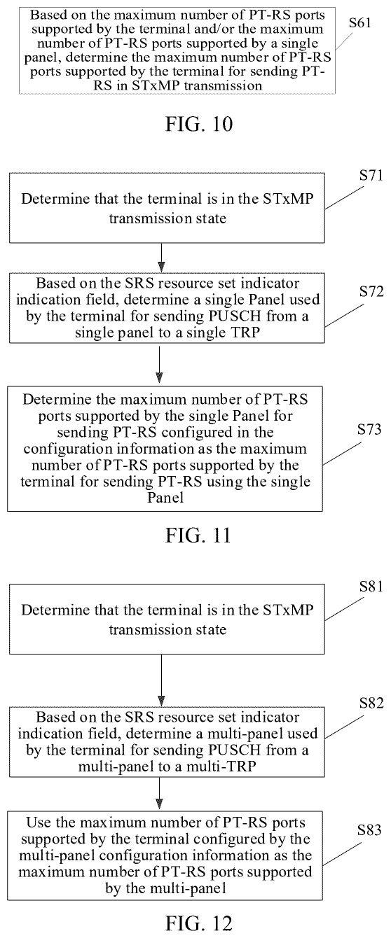

FIG. 10 is a flowchart of a reference signal configuration method according to an exemplary embodiment. As shown in FIG. 10, the method includes the following steps.

In step S61, based on the maximum number of PT-RS ports supported by the terminal and/or the maximum number of PT-RS ports supported by a single panel, the maximum number of PT-RS ports supported by the terminal for sending PT-RS in STxMP transmission is determined.

In the embodiments of the present disclosure, the maximum numbers of PT-RS ports supported by a single panel and a terminal are determined through RRC configuration information.

For example, for determining the maximum number of PT-RS ports supported by the terminal: the maximum number of PT-RS ports supported by the terminal is determined through the current RRC configuration information.

In the embodiments of the present disclosure, the maximum number of PT-RS ports supported by the terminal and/or the maximum number of PT-RS ports supported by the single Panel is determined according to the above-mentioned method, and based on the maximum number of PT-RS ports supported by the terminal and/or the maximum number of PT-RS ports supported by the single Panel, the maximum number of PT-RS ports supported by the terminal for sending PT-RS in STxMP transmission is determined, so that the maximum number of PT-RS ports supported by the terminal for sending PT-RS in STxMP transmission is consistent with the maximum number of PT-RS ports supported by the Panel for sending PT-RS in STxMP transmission, thereby achieving consistent understanding of the configuration between the Panel and the terminal when sending PT-RS in STxMP transmission.

In one implementation of the embodiments of the present disclosure, if the current transmission falls back to the STRP transmission state, that is, the terminal sends PUSCH from a single Panel to a single TRP, the maximum number of PT-RS ports corresponding to sending Panel indicated under STRP should according to the maximum number of PT-RS ports configured by the network device for the Panel.

Under S-DCI, the Panel used by the terminal when falling back to the STRP transmission state can be determined by the SRS resource set indicator indication field in the DCI. The SRS resource set indicator indication field is used to indicate the dynamic switching of single TRP/Panel/TCI/TO and multi-TRP/Panel/TCI/TO, and different code points can be used to indicate which TRP/Panel/TCI/TO is used when sending a single TRP/Panel/TCI/TO.

In one implementation of the reference signal configuration method provided by an embodiment of the present disclosure, in response to the terminal being in STxMP transmission, based on an SRS resource set indicator indication field, a single Panel used by the terminal for sending PUSCH from a single Panel to a single TRP is determined, and the maximum number of PT-RS ports configured by the network device for the determined single Panel is determined as the maximum number of PT-RS ports supported by the single Panel for sending PT-RS in sending PUSCH from a single Panel to a single TRP.

FIG. 11 is a flowchart of a method for determining a single Panel used by a terminal for sending PUSCH from a single Panel to a single TRP according to an exemplary embodiment. As shown in FIG. 11, the method includes the following steps.

In step S71, it is determined that the terminal is in the STxMP transmission state.

In step S72, based on the SRS resource set indicator indication field, a single panel used by the terminal for sending PUSCH from a single panel to a single TRP is determined.

In step S73, a maximum number of PT-RS ports supported by the single Panel for sending PT-RS configured in the configuration information is determined as the maximum number of PT-RS ports supported by the terminal for sending PT-RS using the single Panel.

In the embodiments of the present disclosure, the maximum number of PT-RS ports supported by the terminal for sending PT-RS in sending PUSCH from a single Panel to a single TRP is the maximum number of PT-RS ports supported by the terminal configured by the configuration information, which can accurately determine the maximum number of PT-RS ports supported for sending PT-RS using a single Panel, and then can accurately determine the maximum number of PT-RS ports supported by sending PT-RS on the single Panel when falling back to STRP transmission under STxMP transmission configuration.

In one implementation of the reference signal configuration method provided by an embodiment of the present disclosure, in response to the terminal being in STxMP transmission, based on an SRS resource set indicator indication field, the multi-panel used by the terminal for sending PUSCH from multi-panel to multi-TRP is determined, and the maximum number of PT-RS ports supported by the multi-panel is the maximum number of PT-RS ports supported by the terminal configured by the configuration information.

FIG. 12 is a flowchart of a method for determining a multi-panel used by a terminal for sending PUSCH from multi-panel to multi-TRP according to an exemplary embodiment. As shown in FIG. 12, the method includes the following steps.

In step S81, it is determined that the terminal is in the STxMP transmission state.

In step S82, based on the SRS resource set indicator indication field, the multi-panel used by the terminal for sending PUSCH from multi-panel to multi-TRP is determined.

In step S83, the maximum number of PT-RS ports supported by the terminal configured by the multi-panel configuration information is used as the maximum number of PT-RS ports supported by the multi-panel.

In the embodiments of the present disclosure, the maximum number of PT-RS ports supported by the multi-panel for sending PT-RS used by the terminal for sending PUSCH from multi-panel to multi-TRP is the maximum number of PT-RS ports supported by the terminal configured by the configuration information, which can accurately determine the maximum number of PT-RS ports supported for sending PT-RS using the multi-panel.

In the embodiments of the present disclosure, in the PUSCH transmission of the terminal from a single Panel to a single TRP, the number of PT-RS ports actually transmitted by the single Panel is determined based on the number of PUSCH transmission streams in the PUSCH transmission, the grouping of antenna ports corresponding to the number of transmission streams, and the maximum number of PT-RS ports supported by the Panel.

The above method is used to determine the number of PUSCH transmission streams and the grouping of antenna ports corresponding to the number of transmission streams in PUSCH transmission, and then the number of PT-RS ports actually transmitted by a single Panel in the PUSCH transmission from a single Panel to a single TRP of the terminal is determined according to the maximum number of PT-RS ports supported by the Panel.

It can be understood that the transmission mode of PUSCH transmission involved in the above embodiments of the present disclosure includes a PUSCH transmission mode based on scheduling, or a configured grant Type 1, or a configured grant Type 2. That is, the reference signal configuration method provided in the embodiments of the present disclosure is applicable to the PUSCH transmission mode based on scheduling, the configured grant Type 1, and the configured grant Type 2.

It should be noted that the execution process of the reference signal configuration method applied to the terminal in the embodiments of the present disclosure is similar to that of the reference signal configuration method applied to the network device. For details, the description of the above-mentioned related embodiments may be referred to, which will not be repeated here.

The reference signal configuration method provided in the present disclosure is applicable to the procedure of implementing PT-RS configuration enhancement through interaction between a terminal and a network device. In the method of implementing PT-RS configuration enhancement through interaction between a terminal and a network device, the terminal and the network device respectively have the relevant functions of implementing the reference signal configuration method involved in the above-mentioned embodiments, which will not be repeated here.

It should be noted that those skilled in the art can understand that the various implementations/embodiments involved in the embodiments of the present disclosure can be used in conjunction with the aforementioned embodiments or can be used independently. Whether they are used alone or in conjunction with the aforementioned embodiments, the implementation principle is similar. In the implementation of the present disclosure, some embodiments are described in terms of implementation methods used together. Those skilled in the art can understand that such examples are not limitations of the embodiments of the present disclosure.

Based on the same concept, an embodiment of the present disclosure also provides a reference signal configuration apparatus.

It is understandable that the reference signal configuration apparatus provided in the embodiments of the present disclosure includes hardware structures and/or software modules corresponding to the execution of each function in order to realize the above functions. In combination with the units and algorithm steps of each example disclosed in the embodiments of the present disclosure, the embodiments of the present disclosure can be implemented in the form of hardware or a combination of hardware and computer software. Whether a function is executed in the form of hardware or computer software driving hardware depends on the specific application and design constraints of the technical solution. Those skilled in the art may use different methods to implement the described functions for each specific application, but such implementation should not be considered to exceed the scope of the technical solutions of the embodiments of the present disclosure.

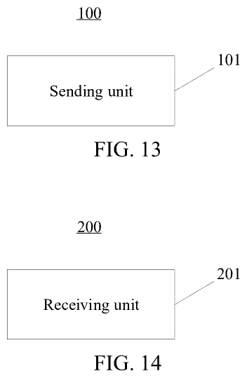

FIG. 13 is a block diagram of a reference signal configuration apparatus according to an exemplary embodiment. Referring to FIG. 13, the reference signal configuration apparatus 100 includes a sending unit 101.

The sending unit 101 is configured to, in response to determining that a terminal performs an S-DCI scheduling mode based simultaneous transmission via multi-Panel (STxMP) physical uplink shared channel (PUSCH), send PT-RS configuration information to the terminal;
where the PT-RS configuration information is used to configure a maximum number of PT-RS ports supported by the terminal for sending a PT-RS using a single panel or a multi-panel in STxMP transmission.

In one implementation, the PT-RS configuration information is used to configure a maximum number of PT-RS ports supported by per single Panel for sending the PT-RS.

In one implementation, the PT-RS configuration information is further used to configure a maximum number of PT-RS ports supported by the terminal for sending the PT-RS in the STxMP transmission.

In one implementation, the sending unit 101 is further configured to:
determine the maximum number of the PT-RS ports supported by the terminal for sending the PT-RS in the STxMP transmission based on the maximum number of the PT-RS ports supported by the terminal and/or the maximum number of the PT-RS ports supported by the single Panel.

In one implementation, the sending unit 101 adopts the following method: in response to the terminal being in the STxMP transmission, determining a single panel used by the terminal for sending PUSCH from a single Panel to a single TRP based on an SRS resource set indicator indication field;
where a maximum number of PT-RS ports supported by the terminal for sending the PT-RS using the single Panel is the maximum number of the PT-RS ports supported by the single Panel for sending the PT-RS configured in the configuration information.

In one implementation, the sending unit 101 adopts the following method: in response to the terminal being in the STxMP transmission, determining a multi-panel used by the terminal for sending PUSCH from multi-panel to multi-TRP based on the SRS resource set indicator indication field, where a maximum number of PT-RS ports supported by the multi-panel is the maximum number of the PT-RS ports supported by the terminal configured by the configuration information.

In one implementation, the number of PT-RS ports actually transmitted by a single Panel in the PUSCH transmission from a single Panel to a single TRP by the terminal is determined based on the number of PUSCH transmission streams in the PUSCH transmission, the grouping of antenna ports corresponding to the number of transmission streams, and the maximum number of PT-RS ports supported by the Panel.

In one implementation, the transmission mode of the PUSCH transmission includes a PUSCH transmission mode based on scheduling, a configured grant Type 1, or a configured grant Type 2.

Based on the same concept, an embodiment of the present disclosure also provides a reference signal configuration apparatus.

FIG. 14 is a block diagram of a reference signal configuration apparatus according to an exemplary embodiment. Referring to FIG. 14, the reference signal configuration apparatus 200 includes a receiving unit 201.

The receiving unit 201 is configured to, in response to the terminal performing an S-DCI scheduling mode based simultaneous transmission via multi-Panel (STxMP) physical uplink shared channel (PUSCH), receive PT-RS configuration information sent by a network device;
where the PT-RS configuration information is used to configure a maximum number of PT-RS ports supported by the terminal for sending PT-RS using a single panel or multi-panel in STxMP transmission.

In one implementation, the PT-RS configuration information is used to configure a maximum number of PT-RS ports supported by per single Panel for sending the PT-RS.

In one implementation, the PT-RS configuration information is further used to configure a maximum number of PT-RS ports supported by the terminal for sending PT-RS in STxMP transmission.

In one implementation, the receiving unit 201 is further configured to determine the maximum number of PT-RS ports supported by the terminal for sending PT-RS in STxMP transmission based on the maximum number of PT-RS ports supported by the terminal and/or the maximum number of PT-RS ports supported by the single panel.

In one implementation, the receiving unit 201 adopts the following manner: in response to the terminal being in STxMP transmission, determining a single panel used by the terminal for sending PUSCH from a single Panel to a single TRP based on the SRS resource set indicator indication field;
where the maximum number of PT-RS ports supported by the terminal for sending PT-RS using the single Panel is the maximum number of PT-RS ports supported by the single Panel for sending the PT-RS in the configuration information.

In one implementation, the receiving unit 201 adopts the following manner: in response to the terminal being in STxMP transmission, determining a multi-panel used by the terminal for sending PUSCH from multi-panel to multi-TRP based on the SRS resource set indicator indication field, where the maximum number of PT-RS ports supported by the multi-panel is the maximum number of the PT-RS ports supported by the terminal configured by the configuration information.

In one implementation, the number of PT-RS ports actually transmitted by the single Panel in the PUSCH transmission from a single Panel to a single TRP by the terminal is determined based on the number of PUSCH transmission streams in the PUSCH transmission, the grouping of antenna ports corresponding to the number of transmission streams, and the maximum number of PT-RS ports supported by the Panel.

In one implementation, the transmission mode of the PUSCH transmission includes a PUSCH transmission mode based on scheduling, a configured grant Type 1, or a configured grant Type 2.

Regarding the apparatuses in the above embodiments, the specific manner in which each module performs operations has been described in detail in the embodiments of the method, and will not be elaborated here.

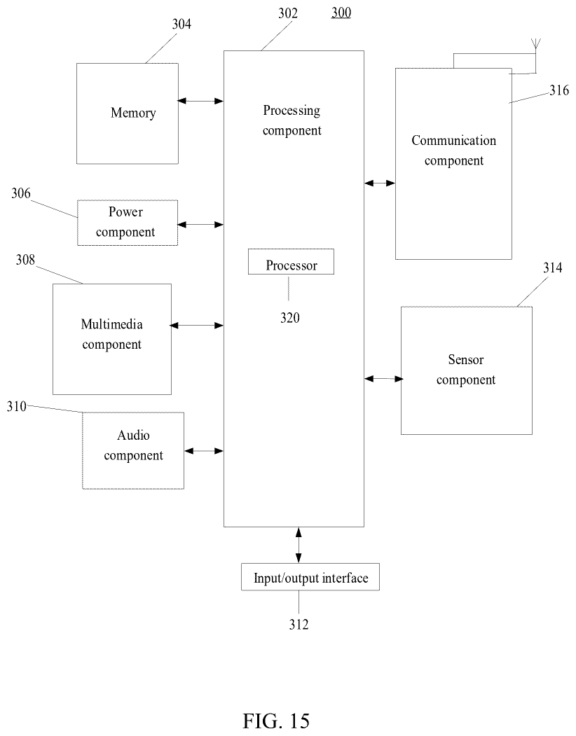

FIG. 15 is a block diagram of an apparatus 300 according to an exemplary embodiment. For example, the apparatus 300 may be a mobile phone, a computer, a digital broadcast terminal, a messaging device, a game console, a tablet device, a medical device, a fitness device, a personal digital assistant, etc.

Referring to FIG. 15, the apparatus 300 may include one or more of the following components: a processing component 302, a memory 304, a power component 306, a multimedia component 308, an audio component 310, an input/output (I/O) interface 312, a sensor assembly 314, and a communication component 316.

The processing component 302 generally controls the overall operation of the apparatus 300, such as operations associated with display, phone calls, data communications, camera operations, and recording operations. The processing component 302 may include one or more processors 320 to execute instructions to complete all or part of the steps of the above-mentioned methods. In addition, the processing component 302 may include one or more modules which facilitate the interaction between the processing component 302 and other components. For example, the processing component 302 may include a multimedia module to facilitate the interaction between the multimedia component 308 and the processing component 302.

The memory 304 is configured to store various types of data to support operations on the apparatus 300. Examples of such data include instructions for any application or method operating on the apparatus 300, contact data, phone book data, messages, pictures, videos, etc. The memory 304 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or optical disk.

The power component 306 provides power to various components of the apparatus 300. The power component 306 may include a power management system, one or more power supplies, and other components associated with the generation, management, and distribution of power to the apparatus 300.

The multimedia component 308 includes a screen that provides an output interface between the apparatus 300 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or slide action, but also detect a duration and a pressure associated with the touch or slide operation. In some embodiments, the multimedia component 308 includes a front camera and/or a rear camera. The front camera and/or the rear camera may receive an external multimedia data while the apparatus 300 is in an operation mode, such as a photographing mode or a video mode. Each of the front camera and rear camera may be a fixed optical lens system or have focus and optical zoom capability.

The audio component 310 is configured to output and/or input audio signals. For example, the audio component 310 includes a microphone (MIC), and when the apparatus 300 is in an operating mode, such as a call mode, a recording mode, and a speech recognition mode, the microphone is configured to receive an external audio signal. The received audio signal can be further stored in the memory 304 or sent via the communication component 316. In some embodiments, the audio component 310 further includes a speaker for outputting audio signals.

The I/O interface 312 provides an interface between the processing component 302 and peripheral interface modules, such as a keyboard, a click wheel, buttons, etc. These buttons may include but are not limited to: a home button, a volume button, a starting button, and a locking button.

The sensor assembly 314 includes one or more sensors for providing assessments of various aspects of the apparatus 300. For example, the sensor assembly 314 can detect an open/closed status of the apparatus 300, relative positioning of components, e.g., the display and the keypad, of the apparatus 300, a change in position of the apparatus 300 or a component of the apparatus 300, a presence or absence of user contact with the apparatus 300, an orientation or an acceleration/deceleration of the apparatus 300, and a change in temperature of the apparatus 300. The sensor assembly 314 may include a proximity sensor configured to detect the presence of a nearby object without any physical contact. The sensor assembly 314 can also include a light sensor, such as a CMOS or CCD image sensor, for use in imaging applications. In some embodiments, the sensor assembly 314 may also include an accelerometer, a gyroscope sensor, a magnetic sensor, a pressure sensor, or a temperature sensor.

The communication component 316 is configured to facilitate wired or wireless communication between the apparatus 300 and other devices. The apparatus 300 can access a wireless network based on a communication standard, such as WiFi, 2G or 3G, or a combination thereof. In an exemplary embodiment, the communication component 316 receives a broadcast signal or broadcast-related information from an external broadcast management system via a broadcast channel. In an exemplary embodiment, the communication component 316 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology and other technologies.

In an exemplary embodiment, the apparatus 300 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components to perform the above method.

In an exemplary embodiment, a non-transitory computer-readable storage medium including instructions is also provided, such as a memory 304 including instructions, and the instructions can be executed by the processor 320 of the apparatus 300 to perform the above method. For example, the non-transitory computer-readable storage medium may be a ROM, a random access memory (RAM), a CD-ROM, a magnetic tape, a floppy disk, an optical data storage device, etc.

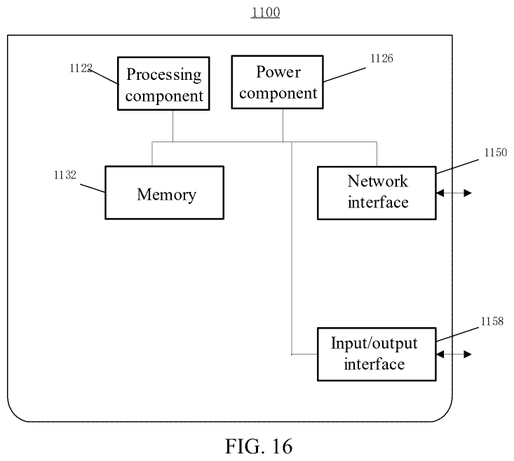

FIG. 16 is a block diagram of an apparatus 1100 for reference signal configuration according to an exemplary embodiment. For example, the apparatus 1100 may be provided as a server. Referring to FIG. 16, the apparatus 1100 includes a processing component 1122, which further includes one or more processors, and a memory resource represented by a memory 1132 for storing instructions executable by the processing component 1122, such as an application. The application stored in the memory 1132 may include one or more modules each corresponding to a set of instructions. In addition, the processing component 1122 is configured to execute the instructions to perform the above methods.

The apparatus 1100 may also include a power component 1126 configured to perform power management of the apparatus 1100, a wired or wireless network interface 1150 configured to connect the apparatus 1100 to a network, and an input/output (I/O) interface 1158. The apparatus 1100 may operate based on an operating system stored in the memory 1132, such as Windows Server™, Mac OS X™, Unix™, Linux™, FreeBSD™, or the like.

The technical solutions provided by the embodiments of the present disclosure may include the following beneficial effects: when the terminal performs the a single DCI scheduling mode based simultaneous transmission via multi-Panel (STxMP) PUSCH, the network device configures the configuration information for sending PT-RS, and configures the maximum number of PT-RS ports supported by the terminal for sending the PT-RS using the single panel or multi-panel during STxMP transmission, thereby enhancing the association relationship between the PT-RS port and the DMRS port. Different association mapping indication schemes between PT-RS and DMRS are considered under different transmission multiplexing schemes, thereby supporting accurate estimation of CPE in the case of multi-panel of the terminal.

It is further understood that in the present disclosure, “multiple” refers to two or more than two, and other quantifiers are similar thereto. “And/or” describes the association relationship of associated objects, indicating that three relationships may exist. For example, A and/or B may represent: A exists alone, A and B exist at the same time, and B exists alone. The character “/” generally indicates that the associated objects before and after are in an “or” relationship. The singular forms “a/an,” “the,” and “said” are also intended to include plural forms, unless the context clearly indicates other meanings.

It is further understood that the terms “first,” “second,” etc. are used to describe various information, but such information should not be limited to these terms. These terms are only used to distinguish the same type of information from each other, and do not indicate a specific order or degree of importance. In fact, the expressions “first,” “second,” etc. can be used interchangeably. For example, without departing from the scope of the present disclosure, the first information can also be referred to as the second information, and similarly, the second information can also be referred to as the first information.

It is further understood that, although the operations are described in a specific order in the drawings in the embodiments of the present disclosure, it should not be understood as requiring the operations to be performed in the specific order shown or in a serial order, or requiring the execution of all the operations shown to obtain the desired results. In certain environments, multitasking and parallel processing may be advantageous.

It should be noted that the various modules/units involved in the reference signal configuration apparatus 100 and the reference signal configuration apparatus 200 involved in the embodiments of the present disclosure are only exemplary and are not intended to be limiting. For example, the reference signal configuration apparatus 100 in the embodiments of the present disclosure may also include a receiving unit and/or a processing unit. The reference signal configuration apparatus 200 may also include a sending unit and/or a processing unit. The various units included in the reference signal configuration apparatus 100 and the reference signal configuration apparatus 200 may interact with each other, and may also interact with other network element devices.

Those skilled in the art will readily appreciate other embodiments of the present disclosure after considering the specification and practicing the content disclosed herein. This application is intended to cover any modifications, uses or adaptations of the present disclosure, which follow the general principles of the present disclosure and include common knowledge or customary technical means in the art that are not disclosed in the present disclosure.

It should be understood that the present disclosure is not limited to the precise structures that have been described above and shown in the drawings, and that various modifications and changes may be made without departing from the scope thereof. The scope of the present disclosure is limited only by the scope of the appended claims.

1. A method for configuring a reference signal applied to a network device, the method comprising:
determining that a terminal performs a single downlink control information (DCI) based simultaneous transmission via multi-Panel (STxMP) physical uplink shared channel (PUSCH), and sending phase-tracking reference signal (PT-RS) configuration information to the terminal;
wherein the PT-RS configuration information is used to configure a maximum number of a PT-RS port supported by the terminal for sending a PT-RS using a single Panel or a multi-Panel in an STxMP transmission.

2. The method according to claim 1, wherein the PT-RS configuration information is used to configure the maximum number of the PT-RS port supported by per single Panel for sending the PT-RS.

3. The method according to claim 1, wherein the PT-RS configuration information is further used to configure the maximum number of the PT-RS port supported by the terminal for sending the PT-RS in the STxMP transmission.

4. The method according to claim 3, wherein the method further comprises:
determining the maximum number of the PT-RS port supported by the terminal for sending the PT-RS in the STxMP transmission based on at least one of the maximum number of the PT-RS port supported by the terminal or the maximum number of the PT-RS port supported by the single Panel.

5. The method according to claim 4, wherein the terminal is in the STxMP transmission, a single Panel used by the terminal for sending the PUSCH from a single Panel to a single TRP is determined based on an SRS resource set indicator indication field;
the maximum number of the PT-RS port supported by the terminal for sending the PT-RS using the single Panel is the maximum number of the PT-RS port supported by the single Panel for sending the PT-RS configured in the configuration information.

6. The method according to claim 4, wherein the terminal is in the STxMP transmission, a multi-Panel used by the terminal for sending the PUSCH from a multi-Panel to a multi-TRP is determined based on an SRS resource set indicator indication field, and the maximum number of the PT-RS port supported by the multi-Panel is the maximum number of the PT-RS port supported by the terminal configured in the configuration information.

7. The method according to claim 1, wherein a number of the PT-RS port actually transmitted by the single Panel in a PUSCH transmission of the terminal from a single Panel to a single TRP is determined based on the number of a PUSCH transmission stream in the PUSCH transmission, a grouping of an antenna port corresponding to a number of the PUSCH transmission stream, and the maximum number of the PT-RS port supported by the Panel.

8. The method according to claim 1, wherein a transmission mode of a PUSCH transmission comprises a PUSCH transmission mode based on scheduling, a configured grant Type 1, or a configured grant Type 2.

9. A method for configuring a reference signal applied to a terminal, wherein the method comprises:
performing a single downlink control information (DCI) based simultaneous transmission via multi-panel (STxMP) physical uplink shared channel (PUSCH), and receiving phase-tracking reference signal (PT-RS) configuration information sent by a network device;
wherein the PT-RS configuration information is used to configure a maximum number of a PT-RS port supported by the terminal for sending a PT-RS using a single Panel or a multi-Panel in an STxMP transmission.

10. The method according to claim 9, wherein the PT-RS configuration information is used to configure the maximum number of the PT-RS port supported by per single Panel for sending the PT-RS.

11. The method according to claim 9, wherein the PT-RS configuration information is further used to configure the maximum number of the PT-RS port supported by the terminal for sending the PT-RS in the STxMP transmission.

12. The method according to claim 11, wherein the method further comprises:
determining the maximum number of the PT-RS port supported by the terminal for sending the PT-RS in the STxMP transmission based on at least one of the maximum number of the PT-RS port supported by the terminal or the maximum number of the PT-RS port supported by the single Panel.

13. The method according to claim 12, wherein the terminal is in the STxMP transmission, a single Panel used by the terminal for sending the PUSCH from a single Panel to a single TRP is determined based on an SRS resource set indicator indication field;
the maximum number of the PT-RS port supported by the terminal for sending the PT-RS using the single Panel is the maximum number of the PT-RS port supported by the single Panel for sending the PT-RS in the configuration information.

14. The method according to claim 12, wherein the terminal is in the STxMP transmission, a multi-Panel used by the terminal for sending the PUSCH from a multi-Panel to a multi-TRP is determined based on an SRS resource set indicator indication field, and the maximum number of the PT-RS port supported by the multi-Panel is the maximum number of the PT-RS port supported by the terminal configured in the configuration information.

15. The method according to claim 9, wherein a number of the PT-RS port actually transmitted by the single Panel in a PUSCH transmission of the terminal from a single Panel to a single TRP is determined based on the number of a PUSCH transmission stream in the PUSCH transmission, a grouping of an antenna port corresponding to a number of the PUSCH transmission stream, and the maximum number of the PT-RS port supported by the Panel.

16. The method according to claim 9, wherein a transmission mode of a PUSCH transmission comprises a PUSCH transmission mode based on scheduling, a type 1 transmission mode of PUSCH based on a non-scheduling, or a type 2 transmission mode of PUSCH based on the non-scheduling.

17.-18. (canceled)

19. An apparatus for configuring a reference signal, the apparatus comprising:
a processor; and
a memory for storing instructions executable by the processor;
wherein the processor is configured to:
determine that a terminal performs a single downlink control information (DCI) based simultaneous transmission via multi-Panel (STxMP) physical uplink shared channel (PUSCH), and send phase-tracking reference signal (PT-RS) configuration information to the terminal;
wherein the PT-RS configuration information is used to configure a maximum number of a PT-RS port supported by the terminal for sending a PT-RS using a single Panel or a multi-Panel in an STxMP transmission.

20. A non-transitory computer readable storage medium storing instructions, the instructions when executed by a processor of the network device, causes the network device to execute the method according to claim 1.

21. An apparatus for configuring a reference signal, the apparatus comprising:
a processor; and
a memory for storing instructions executable by the processor;
wherein the instructions when executed by the processor cause the apparatus to act as the terminal and perform the method according to claim 9.

22. A non-transitory computer readable storage medium, storing instructions, the instructions when executed by a processor of the network device, cause the network device to execute the method according to claim 9.
